(19) United States
(12) Patent Application Publication
(10) Pub. No.: US 2012/0067445 A1
(43) Pub. Date: Mar. 22, 2012

(54) DEVICE FOR USE OF ANIMAL WASTE GAS EMISSION FOR CONVERSION OF METHANE AND SUPPRESSION OF GLOBAL WARMING

(76) Inventors: TSUNG-HAI CHEN, Yonghe City (TW); Kou-Sing Chen, Yonghe City (TW)

(21) Appl. No.: 12/884,201

(22) Filed: Sep. 17, 2010

(51) Int. Cl. F16K 17/02

(52) U.S. Cl. 137/877

(57) ABSTRACT

A device is provided for handling animal waste gas and suppressing global warming. The device includes a hood, a feces tube that is provided with a first one-way valve, and at least one waste gas tube that is provided with a second one-way valve. The waste gas tube has an end connected to a container. When an animal expels waste gas and fecal matter, the fecal matter is allowed to drop into the feces tube and passes through the first one-way valve. The waste gas is conducted through the second one-way valve into the container for storage. As such, the waste gases expelled from cows and horses can be re-used in order to reduce pollution caused thereby, increase energy sources, and suppress the greenhouse effect of the Earth.

### (a) TECHNICAL FIELD OF THE INVENTION

The present invention generally relates to a device that collects wastes gas, such as marsh gas, expelled from animals, such as cows and horses, for secondary use in order to reduce pollution caused by the waste gas, increase energy sources, and suppress the greenhouse effect of the Earth.

### (b) DESCRIPTION OF THE PRIOR ART

Garlic has been used to feed cattle in order to reduce the emission of waste gas. However, milk produced by cattle feeding garlic carrying the taste of garlic. Besides anthropogenic carbon dioxide emission, the factors that cause global warming of the Earth include methane from waste gas or marsh gas produced by the thousand million cows raised worldwide. These domestic animals give off a surprising amount of carbon emission. The amount of carbon dioxide so emitted takes approximately 20% of the worldwide carbon emission, which is far more than the emission of human transportation. A single cow produces 114 Kg methane each year, which corresponds to 2.6 tons of carbon dioxide equivalent. Therefore, for 100 cows, they can produce 11,400 Kg methane each year, which correspond to 260 tones of carbon dioxide. This is a fearful figure. Some scientists proposed to add extracts of garlic to cow feeds in order to suppress the generation of methane in the animal bodies and reduce one quarter of the methane expelled from the cows. This is an effective way of suppressing the generation of methane by cows, but milks produced by the cows feeding garlic carry the taste of garlic.

The worldwide garlic production is quite great, so that, besides being natural, garlic can also be made an unlimited source of supply. Methane produced by cows is because the grass eaten by cows undergoes enteric fermentation, which produce waste gases, or fecal matters to be expelled through anus of cows. These gases and fecal matters cause severe pollution to the environment. According to reports, the milks produced by cows that feed garlic will be contaminated by garlic.

This makes garlic contained feed only suitable for cattle that are raised for meat not for milk. Garlic is an effective solution in this respect for solving global warming and reducing damage to the Earth caused by animal husbandry. However, without sufficient financial support or change of the current animal husbandry model, the influence of animal husbandry on the global warming issue will be even severer in the near future.

Greenhouse gas emission of agriculture is mostly produced by livestock farming, which takes around 80% of that greenhouse gas emission of the agricultural sector. In a United Nations report of 2006, titled “Livestock's Long Shadow”, it is indicated that animal husbandry is responsible for 18% of the worldwide greenhouse gas emissions. A report of November/December of 2009 indicates that animal husbandry produces a large amount of greenhouse gas, which takes more than 51% of the worldwide greenhouse gas emissions. Taking a period of 100 years, the amount of methane produced by animal husbandry will cause a power of warming that is 25 times of carbon dioxides. For a period of 25 years, the warming power of methane is even as great as 75 times of carbon dioxides.

### SUMMARY OF THE INVENTION

In view of such a severe situation, the present invention aims to provide a device for use of animal waste gas emission for conversion of methane and suppression of global warming. The device collects wastes gas, such as marsh gas, expelled from animals, such as cows and horses, for secondary use in order to reduce pollution caused by the waste gas, increase energy sources, and suppress the greenhouse effect of the Earth

An objective of the present invention is to provide such a device that comprises a hood, which hood has a circumferential rim corresponding to an opening of animal anus and comprises a sealing member mounted along the circumferential rim for closely and tightly positioning the hood around the animal anus, whereby with the arrangement of the sealing member, waste gas expelled from an animal can be effectively received and collected in the hood. Further, fecal matter expelled from the animal can be discharged through a feces tube, while the waste gas is conducted through at least one waste gas tube to pass through a second one-way valve to be stored in a container. As such, with a switch mounted to the container, the waste gas stored in the container can be retrieved for re-use, such as serving as fuel gas. Further, the container can be securely held on the back of the animal by the fastening members that secure the hood to the animal. With such a solution, contamination of milk by garlic taste can be resolved and the waste gas can be effectively collected and re-used to thereby reduce pollution caused thereby, increase energy sources, and suppress the greenhouse effect of the Earth.

Further; the present invention also advantageous in that the device can be made of light-weighted materials, such as plastics, rubber, and cloth, is easily manufactured with reduced costs, allows for free movement of animals without severe constraints, does not need to be removed when the animal is staying in water or feeding milk, and is sanitary and easy for rinsing and cleaning.

Another objective of the present invention is to provide a waste gas collection tank that is composed of an air bladder or a collection barrel. For a bladder, the container can be mounted on the back of an animal to provide additional functions of shading of sun light and sheltering against rain and snow. For a collection barrel, the container can be used to simultaneously collect the waste gases from a number of animals for re-use.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a device for collecting waste gas according the present invention, which is mounted on an animal.

FIG. 2 is a schematic view illustrating waste gas expelled from the animal.

FIG. 2A is a schematic view illustrating the operation of a second one-way valve of the device according to the present invention.

FIG. 2B is an enlarged view of a circled portion of FIG. 2.

FIG. 3 is a schematic view illustrating fecal matter expelled from the animal.

FIG. 3A is a schematic view illustrating the operation of a first one-way valve of the device according to the present invention.

FIG. 3B is an enlarged view of a circled portion of FIG. 3.

FIG. 4 is a schematic view showing a device according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

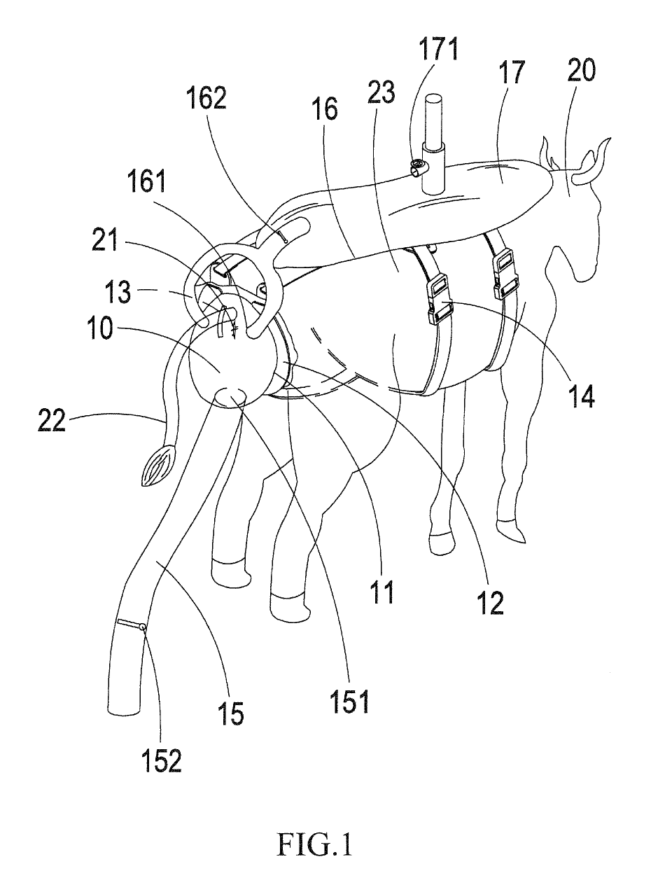

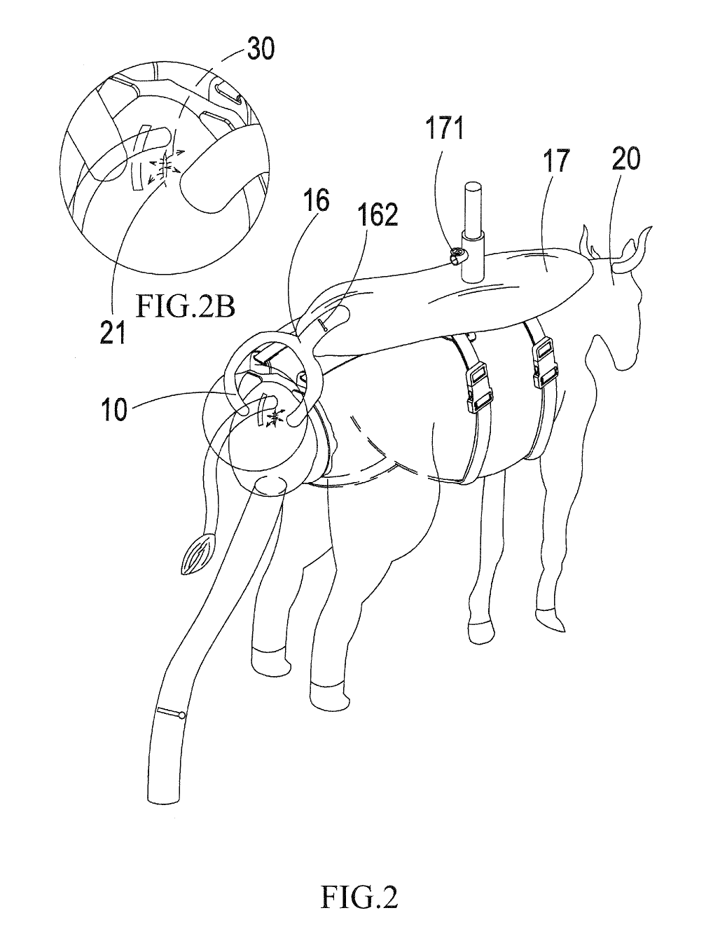

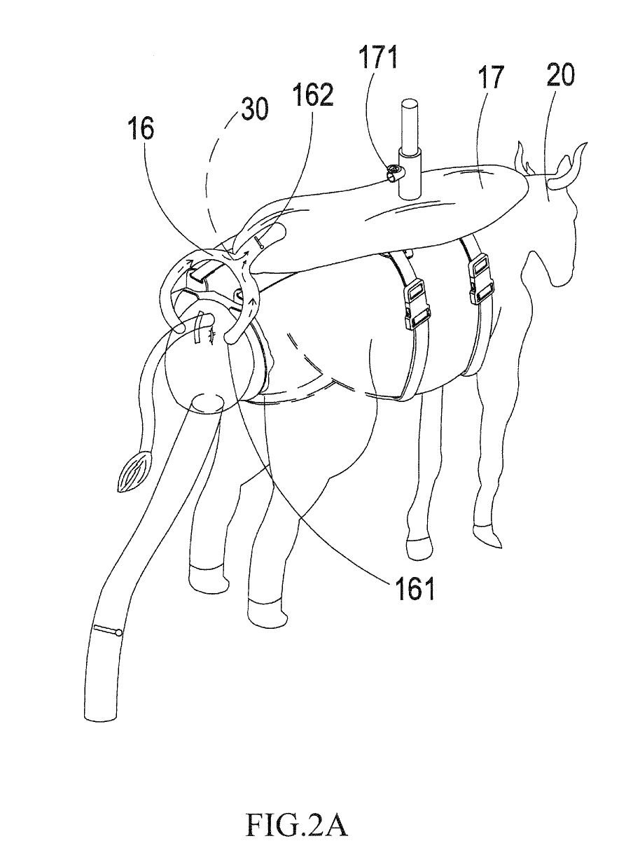

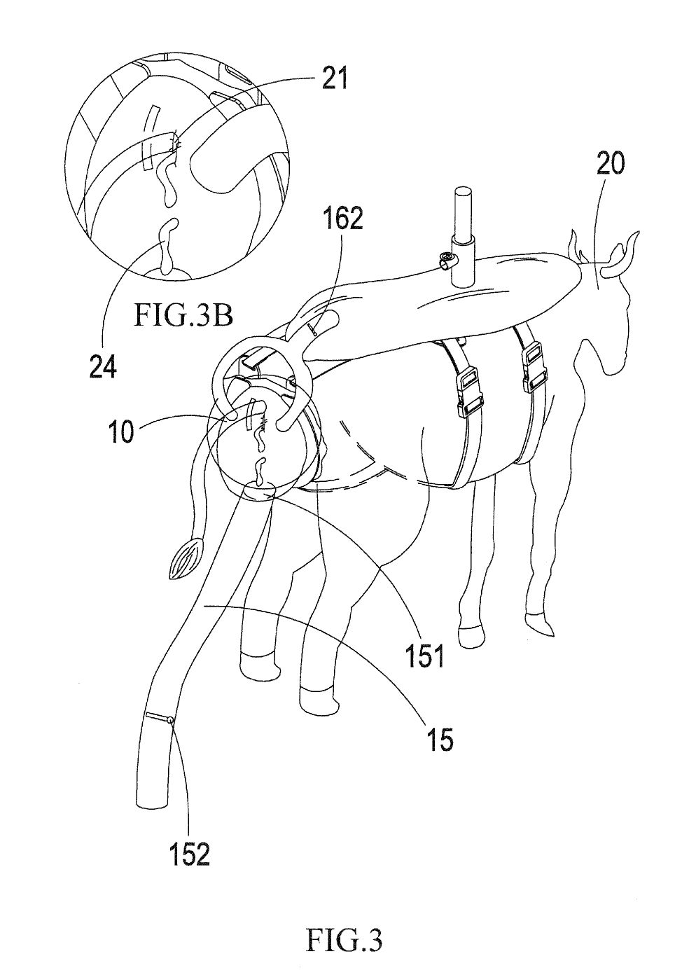

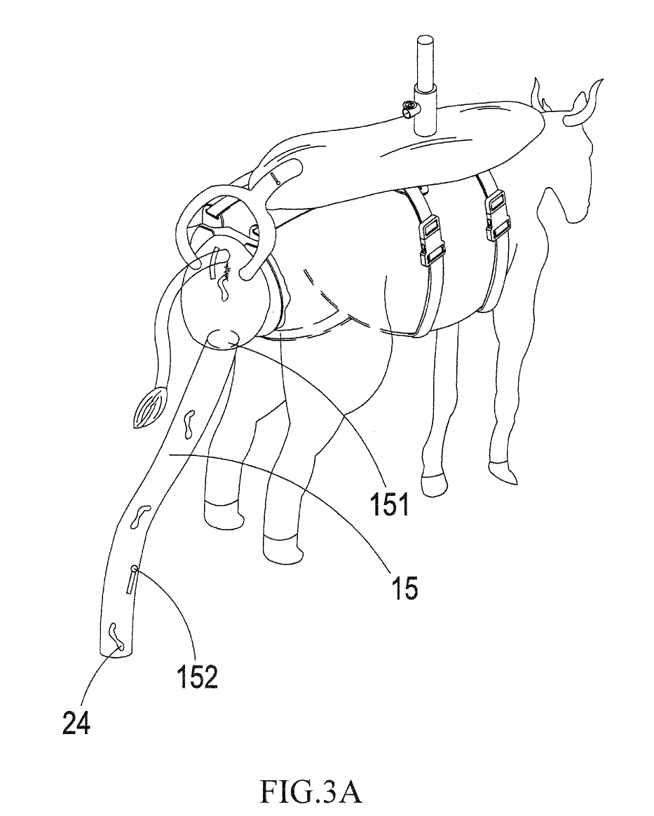

Referring to FIGS. 1, 2, 2A (and 2B), 3, and 3A (and 3B), these respectively show a schematic view of a device for collecting waste gas according the present invention mounted on an animal (a cow in this example), a schematic view illustrating waste gas expelled from the animal, a schematic view illustrating the operation of a second one-way valve of the device according to the present invention, a schematic view illustrating fecal matter expelled from the animal, and a schematic view illustrating the operation of a first one-way valve of the device according to the present invention.

The device according to the present invention comprises a hood 10 for covering anus 21 of an animal 20, which can be a cow or a horse (a cow being shown in the drawings as an example). The hood 10 has a circumferential rim corresponding to an opening 11 of the anus 21 of the animal 20 and a sealing member 12 is mounted along the circumferential rim for closely and tightly engaging around the anus 21 of the animal 20. The sealing member 12 can be made of a foaming material. The hood 10 forms, at a predetermined location, an opening 13 for extension of a tail 22 of the animal 20 therethrough. Further, the hood 10 comprises a plurality of fastening members 14 for securely holding the hood 10 around the anus 21 of the animal 20. Examples of the fastening members 14 include hook-and-loop fastener pads, clips and stretchable bands.

A feces tube 15 has an end connected to a lower side or bottom of the hood 10 to form a feces discharge opening 151. The feces tube 15 comprises a first one-way valve 152 mounted therein.

At least one waste gas tube 16 has an end connected to a predetermined location of the hood 10 to form a waste gas discharge opening 161. The waste gas tube 16 comprises a second one-way valve 162 mounted therein. The waste gas tube 16 has an opposite end that is connected to a container 17 for collecting waste gas 30. The container 17 can be for example an air bladder. The container 17 comprises a switch 171. The bladder is preferably mounted on the back 23 of the animal 20.

When the animal 20 expels waste gas, the waste gas 30 so expelled moves through the waste gas discharge opening 161 to get into the waste gas tube 16. When the amount of waste gas 30 contained in waste gas tube 16 reaches a predetermined level, which generates a predetermined internal pressure, the second one-way valve 162 is opened by the internal pressure to allow the waste gas 30 to flow through the second one-way valve 162 to such an extent that the internal pressure of the waste gas tube 16 drops down to a level insufficient to maintain the second one-way valve 162 in the open condition, whereby the second one-way valve 162 is closed to prevent a reversal flow the waste gas 30 back into the hood 10. The waste gas 30 is thus conducted through the waste gas tube 16 into the container 17, whereby the waste gas 30 is collected and stored in the container 17.

To retrieve the waste gas 30 collected in the container 17, the .171 is opened to allow the waste gas 30 to flow out of the container 17.

Further, when the animal 20 expels fecal matter 24 through the anus 21, the fecal matter 24 drops into the feces tube 15. The fecal matter 24 is driven by the gravity to free fall so that when the fecal matter 24 reaches the first one-way valve 152, the first one-way valve 152 is opened by the gravitational force of the fecal matter 24 to allow the fecal matter 24 to pass the first one-way valve 152. The first one-way valve 152 automatically closes after the fecal matter 24 passes.

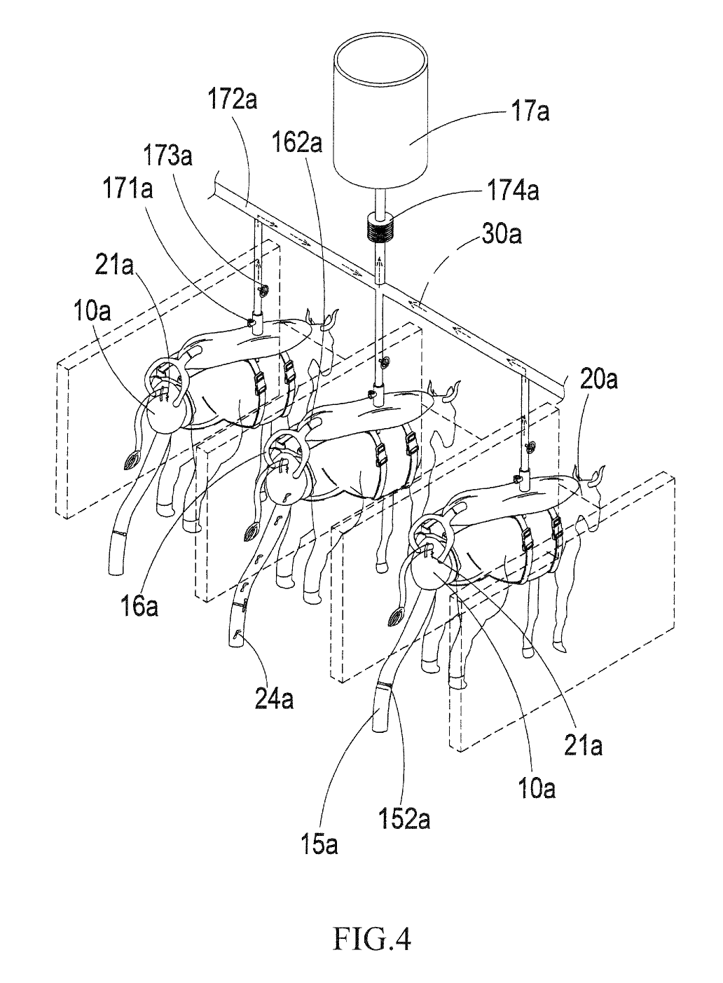

As shown in FIG. 4, which shows a schematic view of another embodiment of the present invention, in this embodiment, the device of the present invention comprises a hood 10a that is set to cover anus 21a of each of a plurality of animals 20a, a feces tube 15a connected to the hood 10a, and at least one waste gas tube 16a connected to the hood 10a. The feces tube 15a comprises a first one-way valve 152a mounted therein and the waste gas tube 16a comprises a second one-way valve 162a mounted therein. The waste gas tube 16a has a distal end connected to a hose like gas conveyance tube 172a. The gas conveyance tube 172a comprises a switch 173a mounted a predetermined location thereof and a pump 174a. The gas conveyance tube 172a is connected to and in communication with a container 17a, which in the embodiment illustrated comprises a collection barrel or tank. As such, when one of the animals 20a expels fecal matter 24a into the feces tube 15a, the first one-way valve 152a is forced open to allow the fecal matter 24a to pass and then closes. Waste gas 30a expelled from the anus 21a of each of the animals 20a is conducted through the waste gas tube 16a into the container (collection barrel) 17a. In this way, all the waste gases 30a from the plurality of animals 20a can be collected together. When a user opens switches 171a, 173a to completely open the gas conveyance tubes 172a and starts the pump 174, the waste gases 30a can be driven by the pump 174 through the gas conveyance tubes 172a into the container 17a.

The present invention shows the following advantages:

(1) The hood 10 is effective in completely collecting and storing the waste gas 30 expelled from an animal 20 and the operation of the second one-way valve 162 allows the waste gas 30 to be collected and stored in the container 17 and the feces tube 15 allows the fecal matter 24 from the animal 20 to be discharged effectively.

(2) The container 17 can be set up on the back 23 of an animal 20, so that the container 17 may provide additional functions of shading of sun light and sheltering against rain and snow.

(3) Pollution caused by animal wastes can be reduced, energy sources can be increased, and global warming can be suppressed.

(4) Animal waste gas can be converted into a re-usable energy source.

(5) Materials used to make the device can be of light weight, such as plastics, rubbers, and cloths.

(6) The manufacturing of the device can be made efficient and costs reduced.

(7) The animal is allowed to freely move without severe constraints and there is no need to remove the device when the animal is staying in water or is feeding milk.

(8) The device is sanitary and rinsing and cleaning is easy.

(9) Animals do not need to feed garlic and the milks produced by the animals are free of the taste of garlic so that the milk can be accepted by the general consumers and at the same time, greenhouse effect can be suppressed.

(10) The fasteners used to secure the device can be of any desired forms, including hook-and-loop fastener pads, clips, or stretchable bands.

As such, the present invention is effective in collecting waste gas for re-use in order to reduce pollution caused by the waste gas, increase energy sources, and suppress the greenhouse effect of the Earth.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device, comprising:
a hood, which is adapted to cove anus of an animal, the hood having a circumferential rim corresponding to an opening of the animal anus and comprising a sealing member mounted along the circumferential rim for closely and tightly engaging around the animal anus;
a feces tube, which has an end connected to a bottom of the hood to form a feces discharge opening, the feces tube comprising a first one-way valve mounted therein; and
at least one waste gas tube, which has an end connected to a predetermined location of the hood to form a waste gas discharge opening, the waste gas tube comprising a second one-way valve 162 mounted therein.

2. The device according to claim 1, wherein the hood comprises a plurality of fastening members for securely holding the hood around the animal anus.

3. The device according to claim 2, wherein the fastening members comprise hook-and-loop fastener pads, clips, or stretchable bands.

4. The device according to claim 1, wherein the hood forms an opening adapted to receive extension of a tail of the animal therethrough.

5. The device according to claim 1, wherein the waste gas tube is connected to a container for collecting waste gas.

6. The device according to claim 5, wherein the container comprises a bladder or a collection barrel.

7. The device according to claim 5, wherein the container comprises a switch mounted thereto.

8. The device according to claim 6, wherein the bladder is adapted to mount on the back of the animal.

9. The device according to claim 1, wherein the animal comprises a cow or a horse.

10. The device according to claim 1, wherein the sealing member comprises a foaming material.
